(19) United States
(12) Patent Application Publication
(10) Pub. No.: US 2019/0085243 A1
(43) Pub. Date: Mar. 21, 2019

(54) NEGATIVE LIQUID CRYSTAL MATERIAL, LIQUID CRYSTAL CELL, AND LIQUID CRYSTAL DISPLAY

(71) Applicant: SHARP KABUSHIKI KAISHA, Sakai City (JP)

(72) Inventor: MASANOBU MIZUSAKI, Sakai City (JP)

(21) Appl. No.: 16/134,847

(22) Filed: Sep. 18, 2018

(30) Foreign Application Priority Data
Sep. 20, 2017 (JP) 2017-179954

(51) Int. Cl. C09K 19/56; G02F 1/137; G02F 1/1337; C09K 19/34; C09K 19/54

(52) U.S. Cl. CPC C09K 19/56; G02F 1/137; G02F 1/133788; C09K 19/3402; C09K 19/54; C09K 2019/3425; G02F 2001/13712; G02F 2001/13775; G02F 1/133723; C09K 2019/548; C09K 19/542

(57) ABSTRACT

A negative liquid crystal material includes a liquid crystal compound and a viscosity-decreasing agent. The liquid crystal compound has a negative dielectric anisotropy. The viscosity-decreasing agent is represented by the following chemical formula (1):

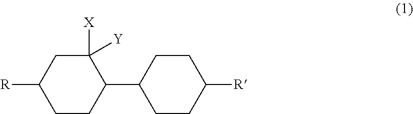

in the chemical formula (1), X and Y are each H or a halogen group, and at least one of X and Y is a halogen group; and R and R′ are each a linear saturated alkyl group having 1 to 5 carbon atoms or a linear saturated alkoxy group having 1 to 5 carbon atoms.

### CROSS REFERENCE TO RELATED APPLICATION

This application claims priority from Japanese Patent Application No. 2017-179954 filed on Sep. 20, 2017. The entire contents of the priority application are incorporated herein by reference.

### TECHNICAL FIELD

The present invention relates to a negative liquid crystal material, a liquid crystal cell, and a liquid crystal display.

### BACKGROUND

A liquid crystal display has a liquid crystal panel as a display part that displays information such as images. The liquid crystal panel includes a liquid crystal cell in which a liquid crystal layer is sealed between a pair of substrates, and a pair of polarizing plates stuck on both sides of the liquid crystal cell. A pair of electrodes for applying a voltage to the liquid crystal layer is provided on both or either of the substrates forming the liquid crystal cell. An alignment of the liquid crystal material, forming the liquid crystal layer, is changed by controlling the voltage applied to between the electrodes, whereby an amount of light passing through the liquid crystal layer is adjusted.

In order to improve a response speed of the liquid crystal panel, a viscosity-decreasing agent, which decreases a viscosity of the liquid crystal material, is usually added to the liquid crystal material as an essential component. As the viscosity-decreasing agent, an alkenyl compound having a dielectric anisotropy of almost zero and having an alkenyl group is used (for example, Japanese Unexamined Patent Publication No. 2010-217853).

There is a case where, as the liquid crystal material, a negative liquid crystal compound having a negative dielectric anisotropy is used. The negative liquid crystal compound includes an organic molecule having a narrow and long structure with a small dielectric constant in a longitudinal direction and a large dielectric constant in a direction orthogonal to the longitudinal direction (minor axis direction). The negative liquid crystal compound is utilized, for example, in a vertical alignment (VA) mode liquid crystal cell, and the like.

There is also a case where a polymerizable component such as a monomer is added to the liquid crystal material in addition to the viscosity-decreasing agent described above. For example, a polymer sustained alignment (PSA) technology is known in which after a liquid crystal material, with which a polymerizable component is previously mixed, is enclosed between substrates, the polymerizable component is polymerized to form a PSA layer on an alignment film (for example, a polyimide alignment film) formed on an inner surface side of the substrate, whereby a pre-tilt angle is imparted to the liquid crystal material (liquid crystal molecule) (see, for example, International Publication WO 2012-121319). In addition, in a liquid crystal alignment technology (conventional alignment film-less liquid crystal alignment technology) in which, without using a conventional alignment film such as a polyimide alignment film, an alignment-expressing functional group is generated from a surface of a polymer layer, which is selectively formed at an interface between a liquid crystal layer and a substrate, and a liquid crystal material (liquid crystal molecule) is aligned utilizing the resulting polymer layer, a polymerizable component such as a monomer is added to the liquid crystal material (see, for example, Japanese Unexamined Patent Publication No. 2006-58755).

There is also a case where an alignment film based on a polyamic acid having a photoreactive functional group such as a cinnamato group (so-called photo-alignment film) is formed on each substrate in a liquid crystal cell.

When the liquid crystal layer contains the viscosity-decreasing agent including the alkenyl compound, a voltage holding ratio (VHR) of a liquid crystal cell may be lowered. When the voltage holding ratio is lowered, it is impossible to perform normal alignment control of the liquid crystal material (liquid crystal molecule), and display defects such as spotting or unevenness are generated on display images on the liquid crystal panel (so-called burning of a liquid crystal panel).

It can be supposed that, for example, in a case of using a negative liquid crystal compound as the liquid crystal material, when light is continuously emitted to the liquid crystal panel from a backlight, a part of the negative liquid crystal compound is excited to generate radicals. It can be supposed that the generated radicals move to an alkenyl group in the alkenyl compound, which is the viscosity-decreasing agent, and the moving radicals remain in the liquid crystal layer (see FIG. 1); as a result, an ionic compound (conductive substance) is generated in the liquid crystal layer, and the voltage holding ratio is lowered.

It can also be supposed that when a polymerizable monomer is added to a liquid crystal material using the PSA technology described above, and the like, radicals, generated from a polymerization initiator (including cases where the polymerizable monomer itself functions as the polymerization initiator) which is added together with the polymerizable monomer, move to an alkenyl group in an alkenyl compound. It can be supposed that the radicals moving to the alkenyl group stably exist in the liquid crystal layer, or the polymerization of the alkenyl compound proceeds by the moving radicals; as a result, a polymer of the alkenyl compound having a radical terminal remains in the liquid crystal layer, thus resulting in the lowered voltage holding ratio.

It can be supposed that, in a case of a liquid crystal panel using a photo-alignment film, when light is continuously emitted to the liquid crystal panel from a backlight, radicals are generated from a photoreactive functional group (for example, a cinnamato group, a chalcone group, or an azobenzene group) contained in the photo-alignment film (see FIG. 2). It can be supposed that the generated radicals move to the alkenyl group in the alkenyl compound, and the moving radicals remain in the liquid crystal layer, whereby the voltage holding ratio is lowered.

### SUMMARY

An object of the present invention is to provide a technology for suppressing the lowering of a voltage holding ratio (VHR) of a liquid crystal cell.

The negative liquid crystal material according to the present invention includes: a liquid crystal compound having a negative dielectric anisotropy; and a viscosity-decreasing agent represented by the following chemical formula (1):

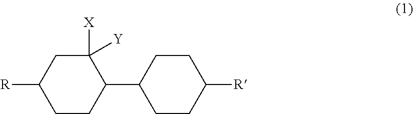

In the formula (1), X and Y are each H or a halogen group, and at least one of X and Y is a halogen group; and R and R′ are each a linear saturated alkyl group having 1 to 5 carbon atoms or a linear saturated alkoxy group having 1 to 5 carbon atoms.

In the negative liquid crystal material described above, it is preferable that the liquid crystal compound has either a functional group represented by the following chemical formula (2-1) or a functional group represented by the following chemical formula (2-2).

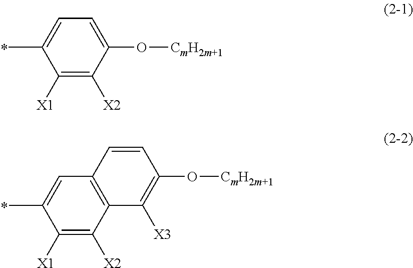

In the formula (2-1) and the formula (2-2), X1, X2, and X3 are independent from each other, and each include an F group or a Cl group; m is an integer of 1 to 18; and “*” represents a bond.

In the negative liquid crystal material described above, it is preferable that the liquid crystal compound has a functional group represented by the following chemical formula (2-3).

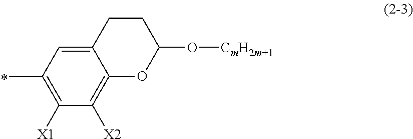

In the formula (2-3), X1 and X2 are independent from each other, and each include an F group or a Cl group; m is an integer of 1 to 18; and “*” represents a bond.

The negative liquid crystal material described above may further include a monomer represented by the following chemical formula (3):

P1-Sp1-Z1A1-Z2ₙSp2-P2 (3)

In the formula (3), P1 and P2 are each independently a polymerizable group including an acrylate group or a methacrylate group; Sp1 and Sp2 are each independently a spacer group, which is a linear, cyclic, or branched saturated alkyl group or unsaturated alkyl group having 1 to 24 carbon atoms, or a direct bond; Z1 and Z2 are independent from each other, and each a group: —O—, a group: —S—, a group: —CO—, a group: —COO—, a group: —OCO—, or a direct bond; Al is a 1,4-phenylene group, a 4,4′-biphenylene group, a 2,6-naphthalene group, a 2,6-anthracene group, a 2,7-phenanthrene group, a 4,4′-chalcone group, or a 4,4′-azobenzene group; and n is an integer of 1 to 3.

The negative liquid crystal material described above may further include a vertical alignment additive.

In the negative liquid crystal material described above, it is preferable that the viscosity-decreasing agent is included in a content of 5% by mass or more and 40% by mass or less.

In the negative liquid crystal material described above, it is preferable that the viscosity-decreasing agent is represented by the chemical formula (1) where both X and Y are the F groups, and both R and R′ are the linear saturated alkyl groups having 1 to 5 carbon atoms.

The liquid crystal cell according to the present invention includes a pair of substrates which face each other; and a liquid crystal layer disposed between the substrates and including any of the negative liquid crystal materials described above.

In the liquid crystal cell described above, the negative liquid crystal material may include a negative liquid crystal material including a monomer represented by the chemical formula (3), and the liquid crystal cell may include a polymer layer including a polymer of the monomer and formed on each facing surface of the pair of substrates.

The liquid crystal cell may include a photo-alignment film, which is formed on a facing surface of at least one substrate of the pair of substrates and expresses an alignment-regulating property to a liquid crystal compound contained in the negative liquid crystal material by light irradiation.

In the liquid crystal cell, it is preferable that the photo-alignment film includes at least one photoreactive functional group selected from the group consisting of a cinnamato group, an azobenzene group, and a chalcone group.

The liquid crystal display according to the present invention includes any of the liquid crystal cells described above.

The present invention can provide a technology for suppressing the lowering of a voltage holding ratio (VHR) of a liquid crystal cell.

### BRIEF DESCRIPTION OF THE DRAWINGS

FIG. 1 is an explanatory diagram showing generation of a radically cationized negative liquid crystal compound and a radically anionized alkenyl compound, resulting from movement of a radical generated from a negative liquid crystal compound by light irradiation to an alkenyl compound;

FIG. 2 is an explanatory diagram showing generation of a radically cationized photoreactive functional group and a radically anionized alkenyl compound, resulting from movement of a radical, generated from each photoreactive functional group of a cinnamato group, a chalcone group, and an azobenzene group in a photo-alignment film to which light is emitted, to an alkenyl compound;

FIG. 3 is an explanatory diagram schematically showing a structure of a liquid crystal display according to a first embodiment;

FIG. 4 is an explanatory diagram schematically showing a structure of a liquid crystal cell of the first embodiment;

FIG. 5 is an explanatory diagram schematically showing a structure of a liquid crystal cell of a second embodiment; and

FIG. 6 is an explanatory diagram schematically showing a structure of a liquid crystal cell of a third embodiment.

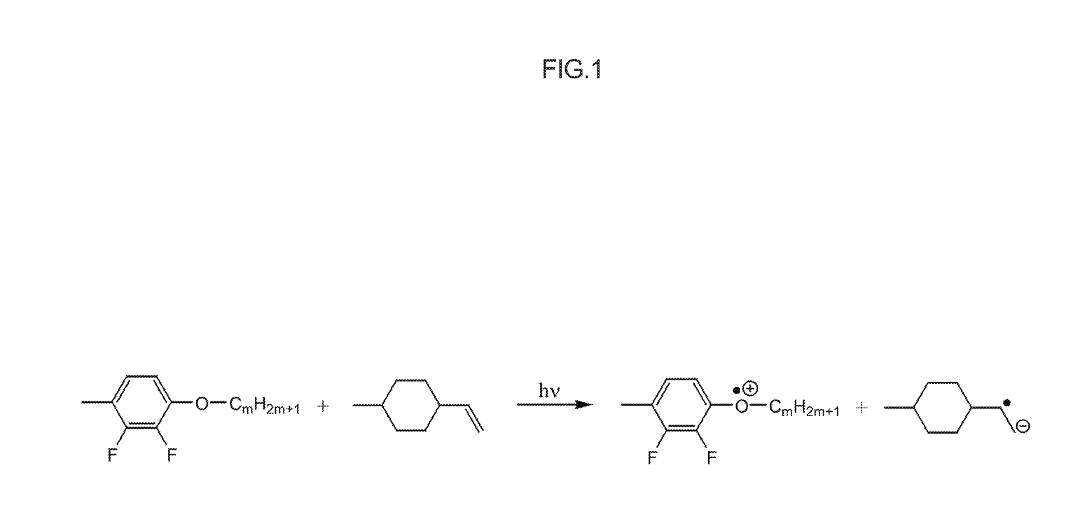

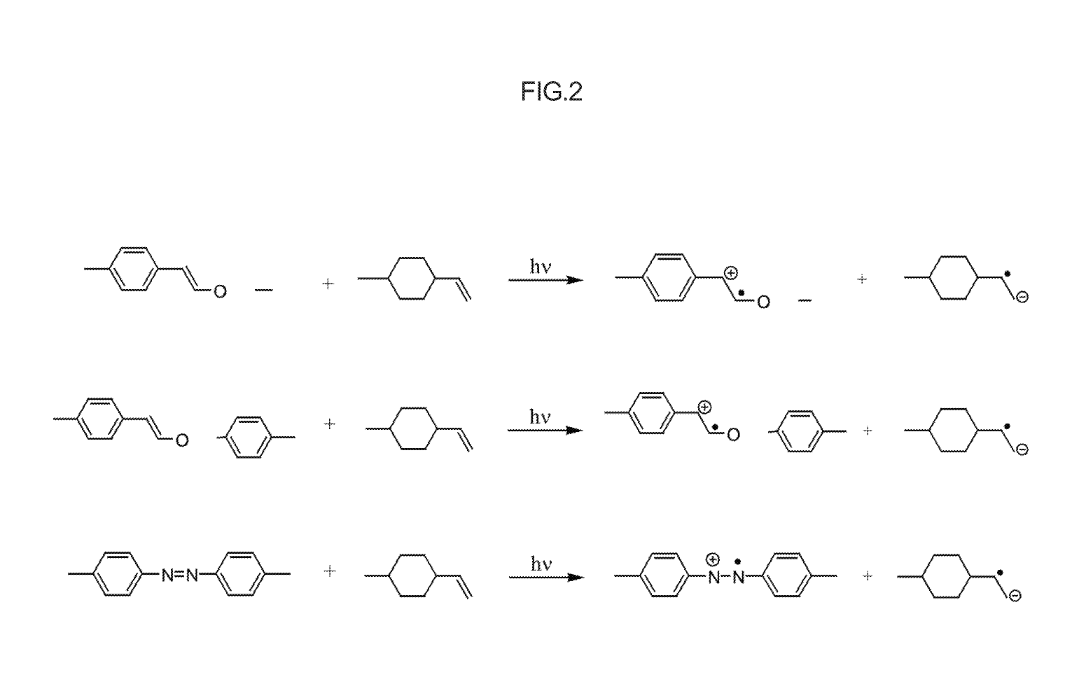

### DETAILED DESCRIPTION

### First Embodiment

(Liquid Crystal Display)

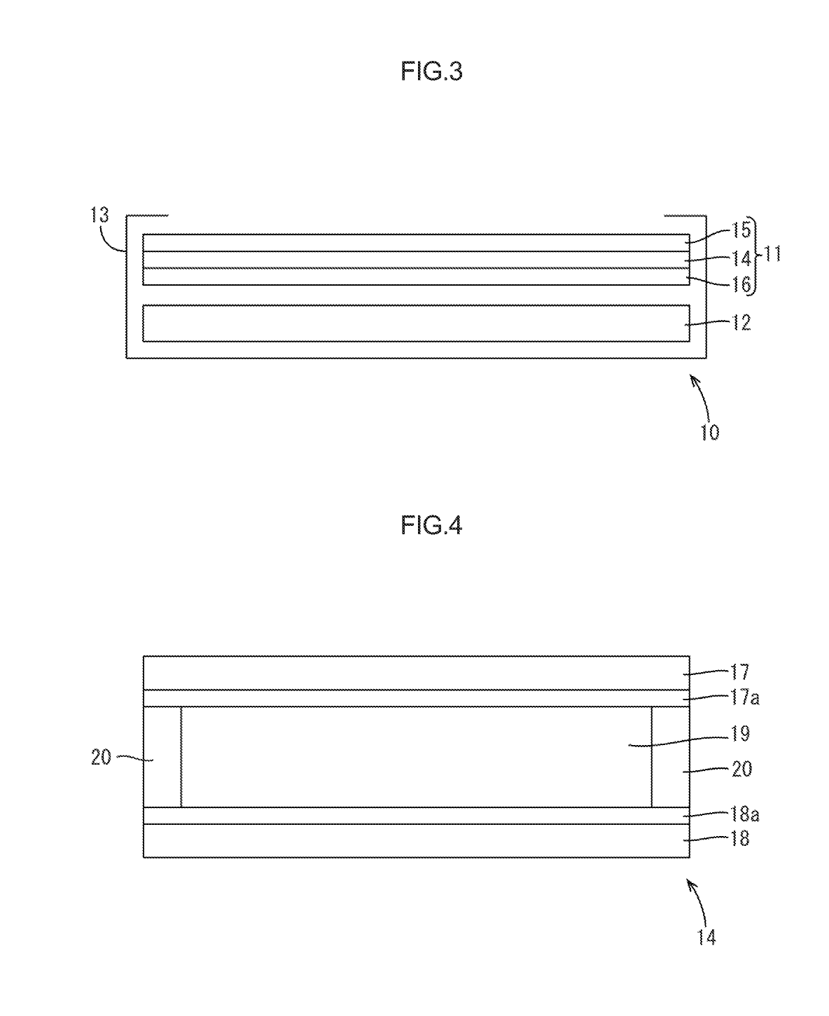

A first embodiment of the present invention is described below, referring to FIGS. 3 and 4. FIG. 3 is an explanatory diagram schematically showing a structure of a liquid crystal display 10 according to the first embodiment. The liquid crystal display 10 mainly includes a liquid crystal panel 11, and a backlight 12 that supplies light to the liquid crystal panel 11. The liquid crystal panel 11 and the backlight 12 are housed in a predetermined housing 13. The liquid crystal panel 11 mainly includes a liquid crystal cell 14 and a pair of polarizing plates 15 and 16, which are stuck to both sides of the liquid crystal cell 14.

(Liquid Crystal Cell)

FIG. 4 is an explanatory diagram schematically showing a structure of the liquid crystal cell 14 of the first embodiment. The liquid crystal cell 14 includes a pair of substrates 17 and 18, which face each other and each have an alignment film 17a or 18a on the corresponding facing surface thereof; a liquid crystal layer 19 interposed between the substrates 17 and 18; and a sealing material 20 interposed between the substrates 17 and 18 in a state of surrounding the liquid crystal layer 19. The one substrate 17 of the pair of substrates 17 and 18 is an array substrate 17, and the other substrate 18 is a counter substrate 18.

(Substrate)

The array substrate 17 includes a thin film transistor (TFT), and the like, formed on a transparent support substrate (for example, a glass substrate), in which the alignment film 17a is formed on a surface facing the other counter substrate 18. The counter substrate 18 includes a color filter (CF) formed on a transparent support substrate (for example, a glass substrate), in which the alignment film 18a is formed on the other surface facing the array substrate 17.

When the liquid crystal cell 14 is in a horizontal alignment mode (for example, a fringe field switching (FFS) mode), a counter electrode formed from a transparent conductive film is formed together with a pixel electrode formed from a transparent conductive film of indium tin oxide (ITO) on the array substrate 17. In such a case, the electrode formed from the transparent conductive film is not formed on the counter substrate 18. On the other hand, when the liquid crystal cell 14 is in a vertical alignment mode, a pixel electrode is formed on the array substrate 17, and a counter electrode is formed on the counter substrate 18. On each electrode formed from the transparent conductive film, a structure for regulating alignment, such as a slit, may be formed if necessary.

(Alignment Film)

The alignment films 17a and 18a are formed from a so-called conventional alignment film including a polymer such as polyimide, polyamide, or polysiloxane. The alignment films 17a and 18a may be a so-called photo-alignment film, which exhibits an alignment-regulating property by light irradiation. The photo-alignment film includes a polymer, such as polyimide, polyamide or polysiloxane, having a photoreactive functional group whose structure is changed by a reaction (for example, a photoisomerization reaction) by applying certain light (for example, polarized ultraviolet light). As the photoreactive functional group, it is preferable to include at least one group selected from the group consisting of a cinnamato group, an azobenzene group, and a chalcone group.

The alignment films 17a and 18a are appropriately selected from among vertical alignment films and horizontal alignment films depending on the object. The alignment films 17a and 18a may be formed on any one substrate of a pair of substrates. The alignment films 17a and 18a may be subjected to an alignment treatment such as a photo-alignment treatment or a rubbing treatment, if necessary.

(Liquid Crystal Layer)

The liquid crystal layer 19 is formed from a negative liquid crystal material containing a liquid crystal compound having a negative dielectric anisotropy, and a viscosity-decreasing agent represented by the following chemical formula (1).

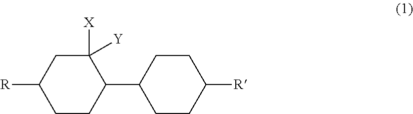

In the formula (1), X and Y are each H or a halogen group, and at least one of X and Y is a halogen group; and R and R′ are each a linear saturated alkyl group having 1 to 5 carbon atoms or a linear saturated alkoxy group having 1 to 5 carbon atoms.

The viscosity-decreasing agent, represented by the chemical formula (1), does not contain an alkenyl group, which easily receives radicals, and is chemically stable.

The preferable viscosity-decreasing agent may include a compound of the chemical formula (1) where both X and Y are the F groups, and both R and R′ are the linear saturated alkyl groups having 1 to 5 carbon atoms. More specifically, the viscosity-decreasing agent may include, for example, compounds represented by the following chemical formula (5-1) and chemical formula (5-2).

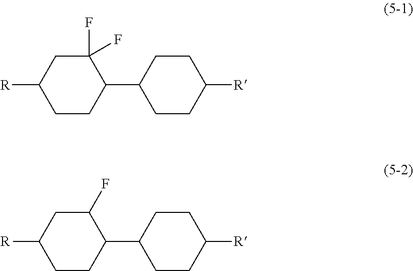

In the formula (5-1) and the formula (5-2), R and R′ are each a linear saturated alkyl group having 1 to 5 carbon atoms or a linear saturated alkoxy group having 1 to 5 carbon atoms.

More specifically, the viscosity-decreasing agent may include, for example, compounds represented by the following chemical formula (6-1), chemical formula (6-2), and chemical formula (6-3).

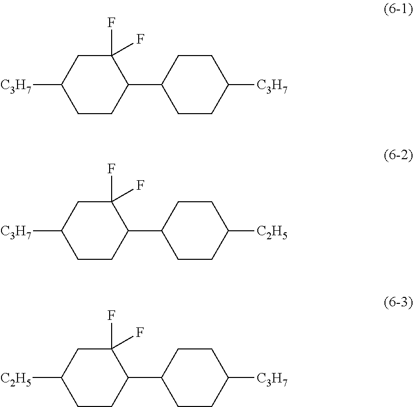

The viscosity-decreasing agent may be used alone or as a mixture of two or more kinds, as long as the objects of the present invention are not impaired. The content of the viscosity-decreasing agent in the liquid crystal layer 19 (negative liquid crystal material) is preferably 5% by mass or more and 40% by mass or less.

The liquid crystal compound (negative liquid crystal compound) having the negative dielectric anisotropy may include, for example, compounds having any one of functional groups represented by the following chemical formula (2-1) and chemical formula (2-2).

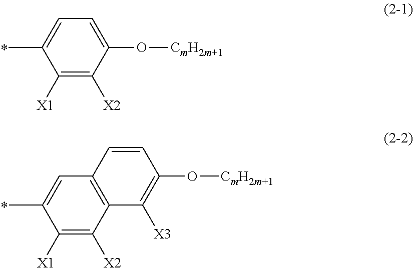

In the formula (2-1) and the formula (2-2), X1, X2, and X3 are independent from each other, and each include an F group or a C1 group; m is an integer of 1 to 18; and “*” represents a bond.

The other liquid crystal compound having a negative dielectric anisotropy (negative liquid crystal compound) may include, for example, compounds having a functional group represented by the following chemical formula (2-3).

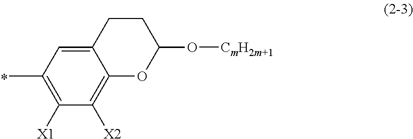

In the formula (2-3), X1l and X2 are independent from each other, and each include an F group or a C1 group; m is an integer of 1 to 18; and “*” represents a bond.

In the negative liquid crystal material, the liquid crystal compound is appropriately selected so as to have a desired negative dielectric anisotropy in accordance with the liquid crystal alignment mode. The negative liquid crystal material may include a liquid crystal compound other than the liquid crystal compounds represented by the formulae (2-1) to (2-3) and other components, as long as the objects of the present invention are not impaired.

(Sealing Material)

The sealing material includes a cured product of a sealing material composition having a photo-curing property and/or a thermosetting property. Such a sealing material is appropriately selected from among known resins including epoxy resins and acrylic resins.

It is supposed that when light is continuously emitted to the liquid crystal cell 14 from the backlight 12, radicals are generated from a part of the negative liquid crystal compound in the liquid crystal layer 19. It is also supposed that the when the alignment films 17a and 18a are formed from the photo-alignment film, radicals are generated from the photo-alignment film due to influence of light from the backlight 12. According to the liquid crystal cell 14 of the present embodiment, however, even if the radicals are generated from the liquid crystal layer 19 or the alignment films 17a and 18a brought into contact with the liquid crystal layer 19, the viscosity-decreasing agent, contained in the liquid crystal layer 19, is chemically stable relative to the radicals and the generation of the stable radicals in the liquid crystal layer 19 is suppressed, which leads to the suppression of the lowering of the voltage holding ratio.

### Second Embodiment

Next, a liquid crystal cell 14A according to a second embodiment of the present invention is described referring to FIG. 5. FIG. 5 is an explanatory diagram schematically showing a structure of the liquid crystal cell 14A of the second embodiment. The liquid crystal cell 14A of the present embodiment utilizes a PSA technology, and includes a pair of substrates 17A and 18A, which face each other and have PSA layers (polymer layers) 21 and 22 on facing surfaces thereof; a liquid crystal layer 19A interposed between the substrates 17A and 18A; and a sealing material 20A interposed between the substrates 17A and 18A in a state of surrounding the liquid crystal layer 19A. One substrate 17A of the pair of substrates 17A and 18A is an array substrate 17A, and the other substrate 18A is a counter substrate 18A.

Basic structures of the array substrate 17A and the counter substrate 18A are the same as those in the liquid crystal cell in the first embodiment described above. However, in the present embodiment, the PSA layer 21 is formed on an alignment film 17Aa on the array substrate 17A, and the PSA layer 22 is formed on an alignment film 18Aa on the counter substrate 18A. The sealing material 20A similar to that in the first embodiment is utilized.

The liquid crystal layer 19A is formed utilizing a negative liquid crystal material including a liquid crystal compound having a negative dielectric anisotropy, a viscosity-decreasing agent represented by the chemical formula (1), and a polymerizable monomer represented by the following chemical formula (3). As the liquid crystal compound having the negative dielectric anisotropy and the viscosity-decreasing agent, those exemplified in the first embodiment are utilized.

P1-Sp1-Z1A1-Z2ₙSp2-P2 (3)

In the formula (3), P1 and P2 are each independently a polymerizable group including an acrylate group or a methacrylate group; Sp1 and Sp2 are each independently a spacer group, which is a linear, cyclic, or branched saturated alkyl group or unsaturated alkyl group having 1 to 24 carbon atoms, or a direct bond; Z1 and Z2 are independent from each other, and each a group: —O—, a group: —S—, a group: —CO—, a group: —COO—, a group: —OCO—, or a direct bond; Al is a 1,4-phenylene group, a 4,4′-biphenylene group, a 2,6-naphthalene group, a 2,6-anthracene group, a 2,7-phenanthrene group, a 4,4′-chalcone group, or a 4,4′-azobenzene group; and n is an integer of 1 to 3.

The PSA layers 21 and 22 are layers of a polymer, obtained by a radical polymerization of the polymerizable monomer, contained in the negative liquid crystal material, in the liquid crystal layer 19A, which are formed on the alignment films 17Aa and 18Aa. The content of the monomer in the negative liquid crystal material is not particularly limited as long as the objects of the present invention are not impaired, and it is preferably, for example, from 0.01% by mass to 5% by mass, more preferably from 0.05% by mass to 1% by mass.

As the monomer, polymerizable monomers having an initiator function, which generates radicals by light irradiation from black light, as described below, are preferable. Such a polymerizable monomer having the initiator function generates radicals, for example, by a photo-Fries rearrangement reaction. When the monomer represented by the chemical formula (3) does not produce radicals, a radical polymerization initiator is appropriately added to the negative liquid crystal material.

In the liquid crystal cell 14A, the alignment films 17Aa and 18Aa are provided as well as the PSA layers 21 and 22 brought into contact with the liquid crystal layer 19A are formed, whereby a pre-tilt angle is imparted to the liquid crystal compound in the liquid crystal layer 19A.

According to such a liquid crystal cell 14A, there is a case where radicals are generated from the negative liquid crystal compound and the photo-alignment film, as in the first embodiment. Further, radicals are generated from the monomer in the liquid crystal layer 19A when the PSA layers 21 and 22 are formed. However, in the liquid crystal cell 14A of the present embodiment, the viscosity-decreasing agent, contained in the liquid crystal layer 19A, is chemically stable relative to the radicals, and thus the generation of radicals stably existing in the liquid crystal layer 19A can be suppressed, thus resulting in the suppression of the lowering of the voltage holding ratio.

### Third Embodiment

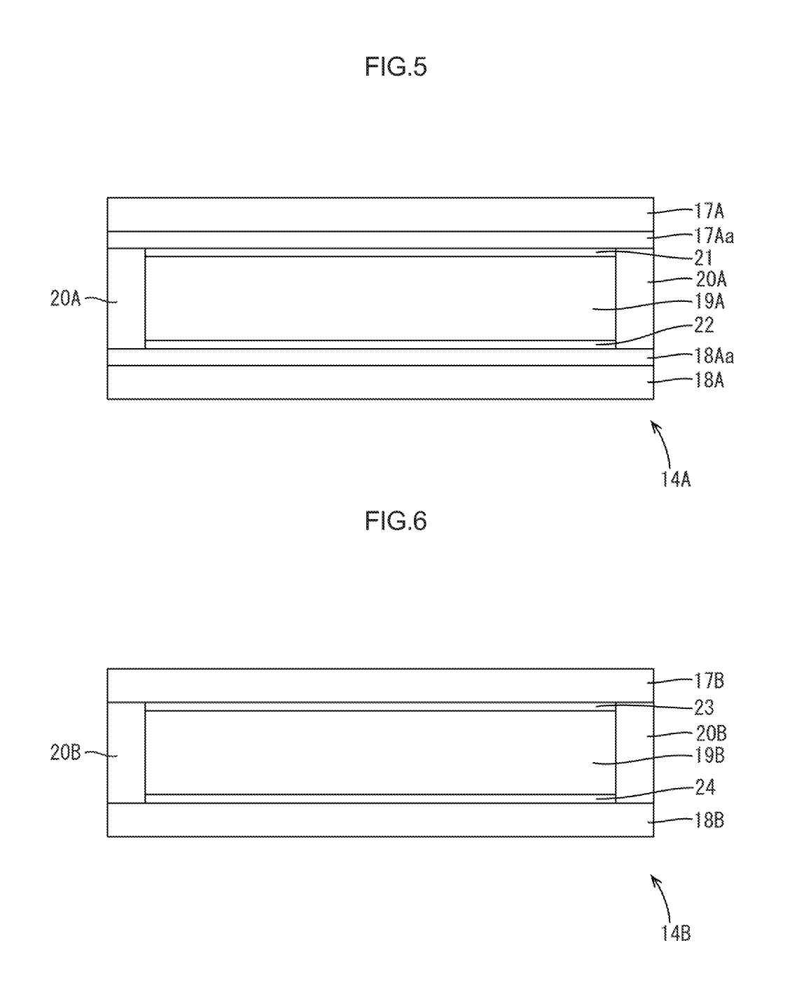

Next, a liquid crystal cell 14B according to a third embodiment of the present invention is described referring to FIG. 6. FIG. 6 is an explanatory diagram schematically showing a structure of the liquid crystal cell 14B of the third embodiment. The liquid crystal cell 14B of the present embodiment utilizes the conventional alignment film-less liquid crystal alignment technology, and includes a pair of substrates 17B and 18B having polymer layers 23 and 24 on facing surfaces thereof, a liquid crystal layer 19B interposed between the substrates 17B and 18B, and a sealing material 20B interposed between the substrates 17B and 18B in a state of surrounding the liquid crystal layer 19B. One substrate 17B of the pair of substrates 17B and 18B is an array substrate 17B, and the other substrate 18B is a counter substrate 18B. A conventional alignment film of polyimide or the like is not formed on either the array substrate 17B or the counter substrate 18B, and the polymer layers 23 and 24 are formed while covering an electrode (a pixel electrode or a counter electrode). A liquid crystal alignment mode in the liquid crystal layer 19B in a voltage non-applied state is defined by the polymer layers (PSA layers) 23 and 24, and a structure for regulating alignment (not shown) (an uneven shape formed on the electrode or the like).

Basic structures of the array substrate 17B and the counter substrate 18B are the same as those in the liquid crystal cell of the first embodiment described above, except that the polymer layers 23 and 24 are formed and the conventional alignment film is not formed. The polymer layers 23 and 24 include layers of a polymer, obtained by radical polymerization of a polymerizable monomer represented by the chemical formula (3) in the liquid crystal layer 19B, as the PSA layers (polymer layers) 21 and 22 exemplified in the second embodiment. The sealing material 20B similar to that in the first embodiment is utilized.

The liquid crystal layer 19B is formed utilizing a negative liquid crystal material containing a liquid crystal compound having a negative dielectric anisotropy, a viscosity-decreasing agent represented by the chemical formula (1), and a polymerizable monomer represented by the chemical formula (3). As the liquid crystal compound having the negative dielectric anisotropy and the viscosity-decreasing agent, those exemplified in the first embodiment are utilized.

In the present embodiment, the negative liquid crystal material, utilized for the liquid crystal layer 19B, may be further added with a vertical alignment additive, which imparts vertical alignment to the liquid crystal compound in the liquid crystal layer 19B. The vertical alignment additive includes a compound having a polar functional group, which can adhere to the surfaces of the polymer layers 23 and 24 as well as a hydrophobic functional group, which acts for aligning the liquid crystal compound. The specific vertical alignment additive may include, for example, compounds of the following chemical formula (9-1), chemical formula (9-2), and chemical formula (9-3).

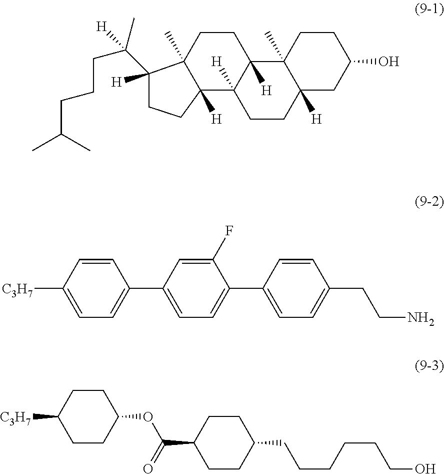

The vertical alignment additive may be used alone or as a mixture of two or more kinds. The content of the vertical alignment additive in the negative liquid crystal material is not particularly limited as long as the objects of the present invention are not impaired, and it is preferably, for example, from 0.01% by mass to 10% by mass, more preferably from 0.1% by mass to 5% by mass.

According to such a liquid crystal cell 14B, there is a case where radicals are generated from the negative liquid crystal compound as in the first embodiment, and radicals are generated from the monomer in the liquid crystal layer 19B when the polymer layers (PSA layers) 23 and 24 are formed as in the second embodiment. However, in the liquid crystal cell 14B of the present embodiment, the viscosity-decreasing agent, contained in the liquid crystal layer 19B, is chemically stable relative to the radical, and thus the generation of radicals stably existing in the liquid crystal layer 19B is suppressed, thus resulting in the suppression of the lowering of the voltage holding ratio.

### EXAMPLES

The present invention is further described below, referring to Examples. The present invention is not limited to Examples at all.

### Example 1

### (Preparation of Negative Liquid Crystal Material E1)

A mixture, obtained by mixing 20% by mass of a viscosity-decreasing agent represented by the chemical formula (6-1) described above with a negative liquid crystal material E0 (a liquid crystal material having a negative dielectric anisotropy) containing each liquid crystal compound represented by the chemical formula (10-1) to the chemical formula (10-9) in a content (% by mass) shown in Table 1, was used as a negative liquid crystal material E1 of Example 1. In the chemical formulae (10-1) to (10-9), R1 and R2 are independent from each other, and each a saturated alkyl group having 1 to 5 carbon atoms. The negative liquid crystal material E0 had a nematic-isotropic phase transition temperature (Tni) of 80° C., a dielectric anisotropy (ΔE) of −2.9, and a refractive index anisotropy (Δn) of 0.09.

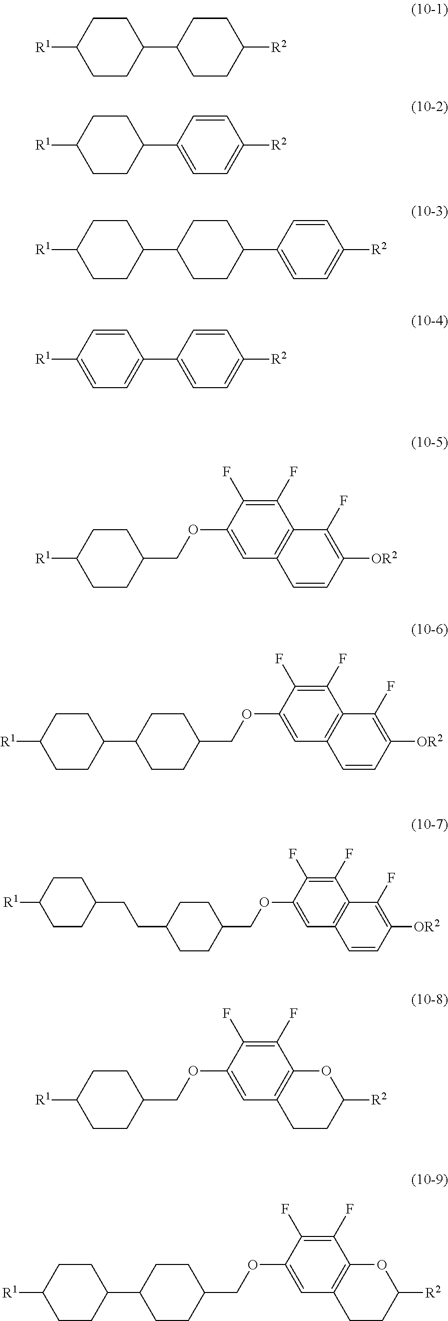

TABLE 1
NEGATIVE LIQUID CRYSTAL MATERIAL E0

| | CONTENT |
|---|---|
| CHEMICAL FORMULA | (% BY MASS) |
| 10-1 | 28 |
| 10-2 | 9 |
| 10-3 | 16 |
| 10-4 | 11 |
| 10-5 | 9 |
| 10-6 | 6 |
| 10-7 | 8 |
| 10-8 | 7 |
| 10-9 | 6 |

(Fabrication of Liquid Crystal Cell)

Using the negative liquid crystal material E1 described above, a liquid crystal cell of Example 1, corresponding to the liquid crystal cell of the first embodiment, was fabricated in the following procedures. First, a pair of substrates, an array substrate and a counter substrate were prepared. An ITO electrode with a slit was formed on each substrate. Alignment films formed on the array substrate and on the counter substrate both included a polyimide vertical alignment film.

When the alignment film was formed, first, an alignment agent in which a polyamic acid was dissolved in an organic solvent was imparted onto each substrate, and a coating film including the alignment agent was formed on the substrate. After that, the coating film on the substrate was heated at a temperature of 90° C. for 5 minutes (pre-baking), followed by heating the coating film at a temperature of 200° C. for 40 minutes (baking). As described above, a vertical alignment film including the polyimide resin was formed on each substrate.

Subsequently, a sealing material composition having a photo-curing property and a thermosetting property was drawn on a surface of the array substrate (alignment film side) in a frame shape using a seal dispenser. Subsequently, light (a wavelength of 280 nm to 400 nm) was emitted to the frame-shaped sealing material composition to pre-cure the sealing material composition. The negative liquid crystal material E1 containing the viscosity-decreasing agent was added dropwise to the inside of the frame formed of the pre-cured sealing composition according to the ODF method. After that, the array substrate and the counter substrate were stuck together with the sealing material composition and the negative liquid crystal material E1 interposed between the substrates, and in this state, the sealing material composition was cured by being heated at a temperature of 130° C. for 40 minutes. Finally, a realignment treatment of the negative liquid crystal material E1 was performed in a manner that the array substrate and the counter substrate, which were stuck together, were heated at 120° C. and quickly cooled, whereby a vertical alignment liquid crystal cell of Example 1 was obtained.

### Comparative Example 1

A mixture, obtained by mixing 5% by mass of a viscosity-decreasing agent including an alkenyl compound represented by the following chemical formula (11) with the negative liquid crystal material E0, was used as a negative liquid crystal material C1 of Comparative Example 1.

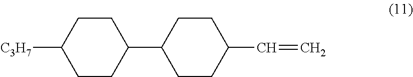

A liquid crystal cell of Comparative Example 1 was fabricated in the same manner as in Example 1 except that the negative liquid crystal material C1 was used instead of the negative liquid crystal material E1 of Example 1.

### Comparative Example 2

A liquid crystal cell of Comparative Example 2 was fabricated in the same manner as in Example 1 except that the negative liquid crystal material E0 containing no viscosity-decreasing agent was used instead of the negative liquid crystal material E1 of Example 1.

[Evaluation of Voltage Holding Ratio (VHR]Voltage holding ratios (VHR) (%) of the liquid crystal cells of Example 1 and Comparative Examples 1 and 2 were measured using a 6254 type VHR measurement system, manufactured by TOYO Corporation, under conditions of 1 V and 70° C. before exposure of backlight and after exposure of backlight for 500 hours. The results are shown in Table 2.

[Evaluation of Response Characteristic]

A response characteristic of each liquid crystal cell of Example 1 and Comparative Examples 1 and 2 was evaluated before the exposure of the backlight. Specifically, rising response time τr (ms), which was a time required for changing a transmittance from 10% to 90% when a voltage applied to the liquid crystal cell was increased from 0.5 V to 7 V, was measured using “Photal 5200” (manufactured by Otsuka Electronics Co., Ltd.). In addition, decay response time rd (ms), which was a time required for changing the transmittance from 90% to 10% when the voltage applied to the liquid crystal cell was lowered from 7 V to 0.5 V, was measured. The results are shown in Table 2.

TABLE 2

| | NEGATIVE LIQUID | | | | | |
|---|---|---|---|---|---|---|
| | CRYSTAL MATERIAL | | VHR (%) | | RESPONSE | |
| | | VISCOSITY- | BEFORE | AFTER | CHARACTERISTIC | |
| | | DECREASING | EXPOSURE | EXPOSURE FOR | τr | τd |
| | KIND | AGENT | TO BACKLIGHT | 500 HOURS | (ms) | (ms) |
| EXAMPLE 1 | E1 | FORMULA (6-1) | 99.4 | 99.1 | 7.7 | 7.9 |
| | | (20 wt %) | | | | |
| COMPARATIVE | C1 | FORMULA (11) | 99.4 | 97.3 | 7.6 | 7.9 |
| EXAMPLE 1 | | (5 wt %) | | | | |
| COMPARATIVE | E0 | NONE | 99.4 | 99.1 | 9.1 | 12.8 |
| EXAMPLE 2 | | | | | | |

Example 1 was a case where the negative liquid crystal material E1 containing 20% by mass of the viscosity-decreasing agent represented by the chemical formula (6-1) was used. The VHR of the liquid crystal cell of Example 1 was hardly lowered even after the exposure for 500 hours, as compared to the VHR before the exposure. Comparative Example 1 was a case where the negative liquid crystal material C1 containing 5% by mass of the viscosity-decreasing agent, which included the alkenyl compound represented by the chemical formula (11), was used. The VHR of the liquid crystal cell of Comparative Example 1 was remarkably lowered after the exposure for 500 hours, as compared to the VHR before the exposure, although the content of the viscosity-decreasing agent was small. In Comparative Example 2 in which the negative liquid crystal material E0 containing no viscosity-decreasing agent was used, the VHR was not lowered after the exposure for 500 hours. The response characteristic in Example 1 was at the same level as that in Comparative Example 1, and Example 1 and Comparative Example 1 exhibited higher speed responses than that in Comparative Example 2 containing no viscosity-decreasing agent.

### Example 2: Liquid Crystal Cell Having PSA Layer

A product, obtained by mixing 5% by mass of a viscosity-decreasing agent represented by the chemical formula (6-1) and 0.3% by mass of a polymerizable monomer (polymerizable monomer having the initiator function) represented by the following chemical formula (12) with the negative liquid crystal material E0, and allowing the mixture to stand at a temperature of 25° C. for 24 hours to completely dissolve the monomer, was used as a negative liquid crystal material E2 of Example 2.

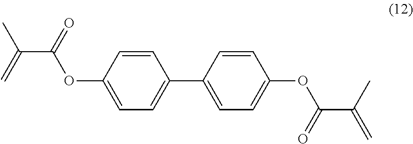 [SMILES: C=C(C)C(=O)Oc1ccc(-c2ccc(OC(=O)C(=C)C)cc2)cc1]

Using the negative liquid crystal material E2 described above, a liquid crystal cell of Example 2, corresponding to the liquid crystal cell of the second embodiment, was fabricated in the following procedures. First, a pair of substrates, an array substrate and a counter substrate, an ITO electrode being formed on each substrate, were prepared. An alignment film on the array substrate and an alignment film on the counter substrate included the same polyimide vertical alignment film as used in Example 1.

When the alignment film was formed, first, an alignment agent, obtained by dissolving a polyamic acid in an organic solvent, was imparted onto each substrate, and a coating film including the alignment agent was formed on each substrate, as in Example 1. After that, the coating film on each substrate was heated at a temperature of 90° C. for 5 minutes (pre-baking), followed by heating the coating film at a temperature of 200° C. for 40 minutes (baking). As described above, a vertical alignment film including the polyimide resin was formed on each substrate.

Subsequently, a sealing material composition having a photo-curing property and a thermosetting property was drawn on a surface of the array substrate (alignment film side) in a frame shape using a seal dispenser, as in Example 1. Subsequently, light (a wavelength of 280 nm to 400 nm) was emitted to the frame-shaped sealing material composition to pre-cure the sealing material composition. The negative liquid crystal material E2 containing the viscosity-decreasing agent and the monomer was added dropwise to the inside of the frame formed of the pre-cured sealing composition according to the ODF method. After that, the array substrate and the counter substrate were stuck together with the sealing material composition and the negative liquid crystal material E2 interposed between the substrates, and in this state, the sealing material composition was cured by being heated at a temperature of 130° C. for 40 minutes. As described above, an unfinished liquid crystal cell, in which the array substrate and the counter substrate were completely stuck together, was obtained.

Black light (“FHF-32BLB” manufactured by TOSHIBA Lighting & Technology Corporation) was emitted to the obtained unfinished liquid crystal cell from a normal direction, with an AC voltage of 10 V being applied, in a room temperature environment for 120 minutes to form a polymer layer (PSA layer) on the vertical alignment film on each substrate. After that, a realignment treatment of the negative liquid crystal material E2 was performed in a manner that the unfinished liquid crystal cell, on which the polymer layer was formed, was heated at 120° C. and quickly cooled, whereby a liquid crystal cell of Example 2 was obtained.

### Examples 3 to 5 and Comparative Examples 3 and 4

Negative liquid crystal materials E3, E4, E5, C3, and C4 of Examples 3 to 5 and Comparative Examples 3 and 4 were prepared in the same manner as in Example 2 except that a content of the viscosity-decreasing agent, represented by the chemical formula (6-1), was changed to a value (% by mass) shown in Table 3.

In addition, liquid crystal cells of Examples 3 to 5 and Comparative Examples 3 and 4 were fabricated in the same manner as in Example 2 except that the negative liquid crystal materials E3, E4, E5, C3, and C4 of Examples 3 to 5 and Comparative Examples 3 and 4 were used instead of the negative liquid crystal material E2 of Example 2.

### Comparative Example 5

A negative liquid crystal material C5 and a liquid crystal cell of Comparative Example 5 was prepared in the same manner as in Example 2 except that 5% by mass of a viscosity-decreasing agent including an alkenyl compound represented by the chemical formula (11), instead of the viscosity-decreasing agent represented by the chemical formula (6-1), was mixed.

[Evaluation of Voltage Holding Ratio (VHR)]

Voltage holding ratios (VHR) (%) of the unfinished liquid crystal cells of Examples 2 to 5 and Comparative Examples 3 to 5 were measured in the same manner as in Example 1 before the irradiation of black light. In addition, voltage holding ratios (VHR) (%) of the liquid crystal cells of Examples 2 to 5 and Comparative Examples 3 to 5 were measured in the same manner as above after the irradiation of black light. The results are shown in Table 3.

[Evaluation of Response Characteristic]

Rising response time τr (ms) and decay response time τd (ms) of the liquid crystal cells of Examples 2 to 5 and Comparative Examples 3 to 5 were measured in the same manner as in Example 1. The results are shown in Table 3.

[Evaluation of Transmittance]

Transmittances (%) of the liquid crystal cells of Examples 2 to 5 and Comparative Examples 3 to 5 were evaluated before the irradiation of backlight. Specifically, using “Photal 5200” (manufactured by Otsuka Electronics Co., Ltd.), a V-T characteristic (voltage transmittance characteristic) was evaluated at a voltage applied to the liquid crystal cell of 0 to 7 V, and a transmittance was measured at a voltage applied of 7 V. In a case where there was no liquid crystal cell, the transmittance was defined as 100%. The results are shown in Table 3.

TABLE 3

| | NEGATIVE LIQUID | | | VHR (%) | | RESPONSE | | |
|---|---|---|---|---|---|---|---|---|
| | CRYSTAL MATERIAL | | | BEFORE | AFTER | CHARAC- | | |
| | | VISCOSITY- | | IRRADIATION | IRRADIATION | TERISTIC | | |
| | | DECREASING | | OF | OF | τr | τd | TRANSMITTANCE |
| | KIND | AGENT | MONOMER | BLACK LIGHT | BLACK LIGHT | (ms) | (ms) | (%) |
| COMPARATIVE | C3 | NONE | FORMULA | 99.4 | 99.1 | 9.2 | 11.6 | 30 |
| EXAMPLE 3 | | (0 WT %) | (12) | | | | | |
| | | | (0.3 WT %) | | | | | |
| EXAMPLE 2 | E2 | FORMULA | FORMULA | 99.4 | 99.0 | 8.2 | 9.0 | 30 |
| | | (6-1) | (12) | | | | | |
| | | (5 WT %) | (0.3 WT %) | | | | | |
| EXAMPLE 3 | E3 | FORMULA | FORMULA | 99.4 | 99.0 | 8.1 | 8.4 | 30 |
| | | (6-1) | (12) | | | | | |
| | | (10 WT %) | (0.3 WT %) | | | | | |
| EXAMPLE 4 | E4 | FORMULA | FORMULA | 99.4 | 98.7 | 7.6 | 7.6 | 30 |
| | | (6-1) | (12) | | | | | |
| | | (25 WT %) | (0.3 WT %) | | | | | |
| EXAMPLE 5 | E5 | FORMULA | FORMULA | 99.4 | 98.9 | 7.6 | 7.6 | 29 |
| | | (6-1) | (12) | | | | | |
| | | (40 WT %) | (0.3 WT %) | | | | | |
| COMPARATIVE | C4 | FORMULA | FORMULA | 99.4 | 98.6 | 7.6 | 7.3 | 24 |
| EXAMPLE 4 | | (6-1) | (12) | | | | | |
| | | (50 WT %) | (0.3 WT %) | | | | | |
| COMPARATIVE | C5 | FORMULA | FORMULA | 99.4 | 93.6 | 7.7 | 7.7 | 30 |
| EXAMPLE 5 | | (11) | (12) | | | | | |
| | | (5 WT %) | (0.3 WT %) | | | | | |

Examples 2 to 5 were cases where 5 to 40% by mass of the viscosity-decreasing agent represented by the chemical formula (6-1) was contained in the liquid crystal layer (liquid crystal material), and Comparative Example 3 was a case where the viscosity-decreasing agent was not contained. In such Examples 2 to 5, as shown in Table 3, the response speed (particularly the rising response time) was higher than in Comparative Example 3, and a high VHR of 98.0% or more could be kept even after the irradiation of black light (after the formation of the polymer layer). Comparative Example 4 was a case where 50% by mass of the viscosity-decreasing agent was contained in the liquid crystal layer. Even in such Comparative Example 4, the response speed was high, and the high VHR was shown after the irradiation of black light (after the formation of the polymer layer), but the transmittance was lowered with an increase in amount of the viscosity-decreasing agent having no polarity, compared to those in Examples 2 to 5 and Comparative Example 3. It can be supposed that this was caused by necessity of a high voltage application in an electric field response of the liquid crystal material, because a percentage of the polar component was decreased by the increase in the amount of the viscosity-decreasing agent.

Comparative Example 5 was a case where 5% by mass of the alkenyl compound represented by the chemical formula (11) was contained, as the viscosity-decreasing agent, in the liquid crystal layer. In such Comparative Example 5, although the response speed became high, the VHR was lowered to 93.6% after the irradiation of black light, caused by a small amount (5% by mass) of the alkenyl compound. It can be supposed that radicals formed from the alkenyl compound by the irradiation of black light (it can be supposed that radicals were generated by a photo-Fries rearrangement reaction of the monomer represented by the chemical formula (12)) moved to alkenyl groups and turned into stable radicals, or the polymerization of the alkenyl compound was advanced; as a result, a polymer of the alkenyl compound having a radical terminal remained in the liquid crystal layer, and thus the VHR was lowered.

As described above, in the PSA type liquid crystal cell, in order to increase the response characteristic, it is effective to use the compound represented by the chemical formula (6-1) as the viscosity-decreasing agent of the liquid crystal material.

### Example 6: Liquid Crystal Cell Having Photo-Alignment Film and PSA Layer

A product, obtained by mixing 5% by mass of a viscosity-decreasing agent represented by the chemical formula (6-1) and 0.6% by mass of a polymerizable monomer (polymerizable monomer having the initiator function) represented by the chemical formula (13) with the negative liquid crystal material E0, and allowing the mixture to stand at a temperature of 25° C. for 24 hours to completely dissolve the monomer, was used as a negative liquid crystal material E6 of Example 6.

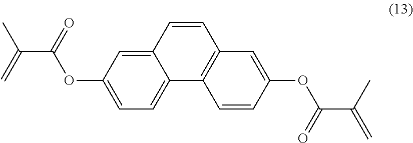 [SMILES: C=C(C)C(=O)Oc1ccc2c(ccc3cc(OC(=O)C(=C)C)ccc32)c1]

Using the negative liquid crystal material E6 described above, a liquid crystal cell of Example 6, corresponding to the liquid crystal cell of the second embodiment, was fabricated in the following procedures. First, a pair of substrates, an array substrate and a counter substrate, an ITO electrode being formed on each substrate, were prepared. An alignment film on the array substrate and an alignment film on the counter substrate were photo-alignment films that express the alignment-regulating property by light irradiation. Specifically, the alignment films each included a polyimide vertical photo-alignment film (a photo-alignment film for UV 2A mode having a cinnamato group as the photoreactive functional group).

When the photo-alignment film was formed, first, a photo-alignment agent, obtained by dissolving a polyamic acid having a cinnamato group as the photoreactive functional group in an organic solvent, was imparted onto each substrate, and a coating film including the photo-alignment agent was formed on the substrate. After that, the coating film on the substrate was heated at a temperature of 90° C. for 5 minutes (pre-baking), followed by heating the coating film at a temperature of 200° C. for 40 minutes (baking). After that, a photo-alignment treatment in which polarized ultraviolet light was emitted to each coating film under a condition of 25 mJ/cm² (an irradiation dose in a wavelength of 320 nm to 340 nm) was performed. As described above, a vertical photo-alignment film including the polyimide resin was formed on each substrate.

Subsequently, a sealing material composition having a photo-curing property and a thermosetting property was drawn on a surface of the array substrate (photo-alignment film side) in a frame shape using a seal dispenser. Subsequently, light (a wavelength of 280 nm to 400 nm) was emitted to the frame-shaped sealing material composition to pre-cure the sealing material composition. The negative liquid crystal material E6 containing the viscosity-decreasing agent and the monomer was added dropwise to the inside of the frame formed of the pre-cured sealing composition according to the ODF method. After that, the array substrate and the counter substrate were stuck together with the sealing material composition and the negative liquid crystal material E6 interposed between the substrates, and in this state, the sealing material composition was cured by being heated at a temperature of 130° C. for 40 minutes. As described above, an unfinished liquid crystal cell, in which the array substrate and the counter substrate were completely stuck together, was obtained.

Black light (“FHF-32BLB” manufactured by TOSHIBA Lighting & Technology Corporation) was emitted to the obtained unfinished liquid crystal cell from a normal direction in an AC voltage non-applied state in a room temperature environment for 60 minutes to form a polymer layer (PSA layer) on the vertical photo-alignment film on each substrate. After that, a realignment treatment of the negative liquid crystal material E6 was performed in a manner that the unfinished liquid crystal cell, on which the polymer layer was formed, was heated at 120° C. and quickly cooled, whereby a liquid crystal cell of Example 6 was obtained.

### Examples 7 to 9 and Comparative Examples 6 and 7

Negative liquid crystal materials E7, E8, E9, C6, and C7 of Examples 7 to 9 and Comparative Examples 6 and 7 were prepared in the same manner as in Example 6 except that a content of the viscosity-decreasing agent, represented by the chemical formula (6-1), was changed to a value (% by mass) shown in Table 4.

In addition, liquid crystal cells of Examples 7 to 9 and Comparative Examples 6 and 7 were fabricated in the same manner as in Example 6 except that the negative liquid crystal materials E7, E8, E9, C6, and C7 of Examples 7 to 9 and Comparative Examples 6 and 7 were used instead of the negative liquid crystal material E6 of Example 6.

### Comparative Example 8

A negative liquid crystal material C8 and a liquid crystal cell of Comparative Example 8 was prepared in the same manner as in Example 6 except that 5% by mass of the viscosity-decreasing agent including the alkenyl compound represented by the chemical formula (11), instead of the viscosity-decreasing agent represented by the chemical formula (6-1), was mixed.

[Evaluation of Voltage Holding Ratio (VHR)]

Voltage holding ratios (VHR) (%) of the unfinished liquid crystal cells of Examples 6 to 9 and Comparative Examples 6 to 8 were measured in the same manner as in Example 1 before the irradiation of black light. In addition, voltage holding ratios (VHR) (%) of the liquid crystal cells of Examples 6 to 9 and Comparative Examples 6 to 8 were measured in the same manner as above after the irradiation of black light. The results are shown in Table 4.

[Evaluation of Response Characteristic]

Rising response time τr (ms) and decay response time τd (ms) of the liquid crystal cells of Examples 6 to 9 and Comparative Examples 6 to 8 were measured in the same manner as in Example 1. The results are shown in Table 4.

[Evaluation of Transmittance]

Transmittances (%) of the liquid crystal cells of Examples 6 to 9 and Comparative Examples 6 to 8 were measured in the same manner as in Example 2 and the like before the irradiation of backlight. The results are shown in Table 4.

TABLE 4

| | NEGATIVE LIQUID | | | VHR (%) | | RESPONSE | | |
|---|---|---|---|---|---|---|---|---|
| | CRYSTAL MATERIAL | | | BEFORE | AFTER | CHARAC- | | |
| | | VISCOSITY- | | IRRADIATION | IRRADIATION | TERISTIC | | |
| | | DECREASING | | OF | OF | τr | τd | TRANSMITTANCE |
| | KIND | AGENT | MONOMER | BLACK LIGHT | BLACK LIGHT | (ms) | (ms) | (%) |
| COMPARATIVE | C6 | NONE | FORMULA | 99.2 | 99.2 | 8.0 | 12.1 | 32 |
| EXAMPLE 6 | | (0 WT %) | (13) | | | | | |
| | | | (0.6 WT %) | | | | | |
| EXAMPLE 6 | E6 | FORMULA | FORMULA | 99.3 | 99.4 | 7.9 | 9.2 | 32 |
| | | (6-1) | (13) | | | | | |
| | | (5 WT %) | (0.6 WT %) | | | | | |
| EXAMPLE 7 | E7 | FORMULA | FORMULA | 99.3 | 99.1 | 7.6 | 8.5 | 32 |
| | | (6-1) | (13) | | | | | |
| | | (10 WT %) | (0.6 WT %) | | | | | |
| EXAMPLE 8 | E8 | FORMULA | FORMULA | 99.2 | 99.2 | 7.1 | 7.7 | 32 |
| | | (6-1) | (13) | | | | | |
| | | (25 WT %) | (0.6 WT %) | | | | | |
| EXAMPLE 9 | E9 | FORMULA | FORMULA | 99.3 | 99.2 | 7.0 | 7.7 | 32 |
| | | (6-1) | (13) | | | | | |
| | | (40 WT %) | (0.6 WT %) | | | | | |
| COMPARATIVE | C7 | FORMULA | FORMULA | 99.2 | 99.0 | 7.0 | 7.7 | 28 |
| EXAMPLE 7 | | (6-1) | (13) | | | | | |
| | | (50 WT %) | (0.6 WT %) | | | | | |
| COMPARATIVE | C8 | FORMULA | FORMULA | 99.3 | 96.0 | 6.9 | 7.7 | 32 |
| EXAMPLE 8 | | (11) | (13) | | | | | |
| | | (5 WT %) | (0.6 WT %) | | | | | |

Examples 6 to 9 were cases where 5 to 40% by mass of the viscosity-decreasing agent represented by the chemical formula (6-1) was contained in the liquid crystal layer (liquid crystal material), and Comparative Example 6 was a case where the viscosity-decreasing agent was not contained. In such Examples 6 to 9, as shown in Table 4, the response speed (particularly the rising response time) was higher than in Comparative Example 6, and a high VHR of 99.0% or more could be kept even after the irradiation of black light (after the formation of the polymer layer). Comparative Example 7 was a case where 50% by mass of the viscosity-decreasing agent was contained in the liquid crystal layer. Even in such Comparative Example 7, the response speed was high, and the high VHR was shown after the irradiation of black light (after the formation of the polymer layer), but the transmittance was lowered with an increase in amount of the viscosity-decreasing agent having no polarity, compared to those in Examples 6 to 9 and Comparative Example 6. It can be supposed that this was caused by necessity of a high voltage application in an electric field response of the liquid crystal material, because a percentage of the polar component was lowered by the increase in the amount of the viscosity-decreasing agent.

Comparative Example 8 was a case where 5% by mass of the alkenyl compound represented by the chemical formula (11) was contained, as the viscosity-decreasing agent, in the liquid crystal layer. In such Comparative Example 8, although the response speed became high, the VHR was lowered to 96.0% after the irradiation of black light, caused by a small amount (5% by mass) of the alkenyl compound. It can be supposed that radicals formed from the alkenyl compound by the irradiation of black light (it can be supposed that radicals were generated from the monomer represented by the chemical formula (13) and the photo-alignment film) moved to alkenyl groups and turned into stable radicals, or the polymerization of the alkenyl compound was advanced; as a result, a polymer of the alkenyl compound having a radical terminal remained in the liquid crystal layer, and thus the VHR was lowered.

As described above, in the PSA type liquid crystal cell using the photo-alignment film containing the cinnamato group as the photoreactive functional group, in order to increase the response characteristic, it is effective to use the compound represented by the chemical formula (6-1) as the viscosity-decreasing agent of the liquid crystal material.

### Example 10: Vertical Alignment Liquid Crystal Cell Including No Conventional Alignment Film

A product, obtained by mixing 20% by mass of a viscosity-decreasing agent represented by the chemical formula (6-2), 0.3% by mass of a polymerizable monomer (polymerizable monomer having the initiator function) represented by the chemical formula (12), and 1.5% by mass of a vertical alignment additive represented by the chemical formula (9-1) with the negative liquid crystal material E0, and allowing the mixture at a temperature of 25° C. for 24 hours to completely dissolve the monomer and the vertical alignment additive, was used as a negative liquid crystal material E10 of Example 10.

Using the negative liquid crystal material E10 described above, a liquid crystal cell of Example 10, corresponding to the liquid crystal cell of the third embodiment, was fabricated in the following procedures. First, a pair of substrates, an array substrate and a counter substrate, an ITO electrode being formed on each substrate, were prepared. The array substrate and the counter substrate did not have a conventional alignment film.

Subsequently, a sealing material composition having a photo-curing property and a thermosetting property was drawn on a surface of the array substrate in a frame shape using a seal dispenser. Subsequently, light (a wavelength of 280 nm to 400 nm) was emitted to the frame-shaped sealing material composition to pre-cure the sealing material composition. The negative liquid crystal material E10 containing the viscosity-decreasing agent and the monomer was added dropwise to the inside of the frame formed of the pre-cured sealing composition according to the ODF method. After that, the array substrate and the counter substrate were stuck together with the sealing material composition and the negative liquid crystal material E10 interposed between the substrates, and in this state, the sealing material composition was cured by being heated at a temperature of 130° C. for 40 minutes. As described above, an unfinished liquid crystal cell, in which the array substrate and the counter substrate were completely stuck together, was obtained.

Subsequently, in order to fix the vertical alignment, black light (“FHF-32BLB” manufactured by TOSHIBA Lighting & Technology Corporation) was emitted to the obtained unfinished liquid crystal cell from a normal direction, with an AC voltage of 10 V being applied, in a room temperature environment for 100 minutes to form a polymer layer on the surface of each substrate. After that, a realignment treatment of the negative liquid crystal material E10 was performed in a manner that the unfinished liquid crystal cell, on which the polymer layer was formed, was heated at 120° C. and quickly cooled, whereby a liquid crystal cell of Example 10 was obtained.

### Example 11

A negative liquid crystal material E11 of Example 11 was prepared in the same manner as in Example 10 except that 1.5% by mass of a compound represented by the chemical formula (9-2) was used as the vertical alignment additive.

In addition, a liquid crystal cell of Example 11 was fabricated in the same manner as in Example 10 except that the negative liquid crystal material E11 was used.

### Example 12

A negative liquid crystal material E12 of Example 12 was prepared in the same manner as in Example 10 except that 1.5% by mass of a compound represented by the chemical formula (9-3) was used as the vertical alignment additive.

In addition, a liquid crystal cell of Example 12 was fabricated in the same manner as in Example 10 except that the negative liquid crystal material E12 was used.

### Comparative Example 9

A negative liquid crystal material C9 of Comparative Example 9 was prepared in the same manner as in Example 10 except that 5% by mass of an alkenyl compound represented by the chemical formula (11) was used as the viscosity-decreasing agent. In addition, a liquid crystal cell of Comparative Example 9 was fabricated in the same manner as in Example 10 except that the negative liquid crystal material C9 was used.

### Comparative Example 10

A negative liquid crystal material C10 of Comparative Example 10 was prepared in the same manner as in Example 11 except that 5% by mass of an alkenyl compound represented by the chemical formula (11) was used as the viscosity-decreasing agent. In addition, a liquid crystal cell of Comparative Example 10 was fabricated in the same manner as in Example 10 except that the negative liquid crystal material C10 was used.

### Comparative Example 11

A negative liquid crystal material C11 of Comparative Example 11 was prepared in the same manner as in Example 12 except that 5% by mass of an alkenyl compound represented by the chemical formula (11) was used as the viscosity-decreasing agent. In addition, a liquid crystal cell of Comparative Example 11 was fabricated in the same manner as in Example 10 except that the negative liquid crystal material C11 was used.

[Evaluation of Voltage Holding Ratio (VHR)]

Voltage holding ratios (VHR) (%) of the unfinished liquid crystal cells of Examples 10 to 12 and Comparative Examples 9 to 11 were measured in the same manner as in Example 1 before the irradiation of black light. In addition, voltage holding ratios (VHR) (%) of the liquid crystal cells of Examples 10 to 12 and Comparative Examples 9 to 11 were measured in the same manner as above after the irradiation of black light. The results are shown in Table 5.

[Evaluation of Response Characteristic]

Rising response time τr (ms) and decay response time τd (ms) of the liquid crystal cells of Examples 10 to 12 and Comparative Examples 9 to 11 were measured in the same manner as in Example 1. The results are shown in Table 5.

TABLE 5

| | NEGATIVE LIQUID | | | | VHR (%) | | | |
|---|---|---|---|---|---|---|---|---|
| | CRYSTAL MATERIAL | | | | BEFORE | AFTER | RESPONSE | |
| | | VISCOSITY- | | VERTICAL | IRRADIATION | IRRADIATION | CHARACTERISTIC | |
| | | DECREASING | | ALIGNMENT | OF | OF | τr | τd |
| | KIND | AGENT | MONOMER | ADDITIVE | BLACK LIGHT | BLACK LIGHT | (ms) | (ms) |
| EXAMPLE | E10 | FORMULA | FORMULA | FORMULA | 98.3 | 97.7 | 7.7 | 8.2 |
| 10 | | (6-2) | (12) | (9-1) | | | | |
| | | (20 WT %) | (0.3 WT %) | (1.5 WT %) | | | | |
| EXAMPLE | E11 | FORMULA | FORMULA | FORMULA | 98.4 | 97.9 | 7.7 | 7.8 |
| 11 | | (6-2) | (12) | (9-2) | | | | |
| | | (20 WT %) | (0.3 WT %) | (1.5 WT %) | | | | |
| EXAMPLE | E12 | FORMULA | FORMULA | FORMULA | 98.1 | 97.5 | 7.6 | 7.8 |
| 12 | | (6-2) | (12) | (9-3) | | | | |
| | | (20 WT %) | (0.3 WT %) | (1.5 WT %) | | | | |
| COMPARATIVE | C9 | FORMULA | FORMULA | FORMULA | 98.2 | 95.1 | 7.6 | 7.9 |
| EXAMPLE 9 | | (11) | (12) | (9-1) | | | | |
| | | (5 WT %) | (0.3 WT %) | (1.5 WT %) | | | | |
| COMPARATIVE | C10 | FORMULA | FORMULA | FORMULA | 98.2 | 94.7 | 7.8 | 8.0 |
| EXAMPLE | | (11) | (12) | (9-2) | | | | |
| 10 | | (20 WT %) | (0.3 WT %) | (1.5 WT %) | | | | |
| COMPARATIVE | C11 | FORMULA | FORMULA | FORMULA | 98.1 | 95.1 | 7.4 | 7.8 |
| EXAMPLE | | (11) | (12) | (9-3) | | | | |
| 11 | | (5 WT %) | (0.3 WT %) | (1.5 WT %) | | | | |

Examples 10 to 12 were cases where the compound represented by the chemical formula (6-2) was used as the viscosity-decreasing agent, and Comparative Examples 9 to 11 were cases where the alkenyl compound represented by the chemical formula (11) was used as the viscosity-decreasing agent. As shown in Table 5, in Examples 10 to 12, the response characteristic, whose value was almost the same as that obtained in Comparative Examples 9 to 11, could be obtained by adding 20% by mass of the viscosity-decreasing agent to the liquid crystal layer. In addition, in Examples 10 to 12, using the viscosity-decreasing agent, the lowering of the VHR was small and the value thereof was 97.0% or more, even after the formation of the polymer layer for fixing the vertical alignment by emitting ultraviolet light from the black light. On the other hand, in Comparative Examples 9 to 11, results in which the VHR was lowered to the 94% level to the 95% level were obtained.

As described above, in the conventional alignment film-less vertical alignment PSA type in which the conventional alignment film was not used, in order to obtain the liquid crystal panel having the excellent response characteristic, it is effective to use the compound represented by the chemical formula (6-2) as the viscosity-decreasing agent.

### Example 13: Liquid Crystal Cell for FFS Mode Having Photo-Alignment Film

A mixture obtained by mixing 25% by mass of a viscosity-decreasing agent represented by the chemical formula (6-3) with the negative liquid crystal material E0 was used as a negative liquid crystal material E13 of Example 13.

Using the negative liquid crystal material E13 described above, a liquid crystal cell of Example 13, corresponding to the liquid crystal cell of the first embodiment (a liquid crystal cell for FFS mode), was fabricated in the following procedures. First, an array substrate for FFS mode having two kinds of ITO electrodes (a pixel electrode and a counter electrode), and a counter substrate facing the array substrate were prepared. An alignment film on the array substrate and an alignment film on the counter substrate both included a photo-alignment film, specifically a polyimide horizontal photo-alignment film (which was a photo-alignment film for FFS mode and had an azobenzene group as the photoreactive functional group).

When the photo-alignment film was formed, first, a photo-alignment agent, obtained by dissolving a polyamic acid having an azobenzene group as the photoreactive functional group in an organic solvent, was imparted onto each substrate, and a coating film including the photo-alignment agent was formed on the substrate. After that, the coating film on the substrate was heated at a temperature of 90° C. for 5 minutes (pre-baking), followed by heating the coating film at a temperature of 120° C. for 20 minutes (primary baking). After that, a photo-alignment treatment in which polarized ultraviolet light was emitted to each coating film under a condition of 2 mJ/cm² (an irradiation dose in a wavelength of 340 nm to 380 nm) was performed. Each coating film was further heated at a temperature of 230° C. for 40 minutes (secondary baking). As described above, a horizontal photo-alignment film including the polyimide resin was formed on each substrate.

Subsequently, a sealing material composition having a photo-curing property and a thermosetting property was drawn on a surface of the array substrate (photo-alignment film side) in a frame shape using a seal dispenser. Subsequently, light (a wavelength of 280 nm to 400 nm) was emitted to the frame-shaped sealing material composition to pre-cure the sealing material composition. The negative liquid crystal material E13 containing the viscosity-decreasing agent was added dropwise to the inside of the frame formed of the pre-cured sealing composition according to the ODF method. After that, the array substrate and the counter substrate were stuck together with the sealing material composition and the negative liquid crystal material E13 interposed between the substrates, and in this state, the sealing material composition was cured by being heated at a temperature of 130° C. for 40 minutes. As described above, a realignment treatment of the negative liquid crystal material E13 was performed in a manner that the material was heated at 120° C. and quickly cooled in the state in which the array substrate and the counter substrate were completely stuck together, whereby a liquid crystal cell of Example 13 was obtained.

### Comparative Example 12

A mixture, obtained by mixing 10% by mass of an alkenyl compound represented by the chemical formula (11) as the viscosity-decreasing agent with the negative liquid crystal material E0, was used as a negative liquid crystal material C12 of Comparative Example 12. In addition, a liquid crystal cell of Comparative Example 12 was fabricated in the same manner as in Example 13 except that the negative liquid crystal material C12 was used.

### Comparative Example 13

A liquid crystal cell of Comparative Example 13 was fabricated in the same manner as in Example 13 except that the negative liquid crystal material E0 containing no viscosity-decreasing agent was used.

[Evaluation of Voltage Holding Ratio (VHR)]

Voltage holding ratios (VHR) (%) of the liquid crystal cells of Example 13 and Comparative Examples 12 and 13 were measured in the same manner as in Example 1 before the irradiation of backlight and after the irradiation of backlight for 500 hours. The results are shown in Table 6.

[Evaluation of Response Characteristic]

Rising response time τr (ms) and decay response time rd (ms) of the liquid crystal cells of Example 13 and Comparative Examples 12 and 13 were measured in the same manner as in Example 1. The results are shown in Table 6.

TABLE 6

| | NEGATIVE LIQUID | | | | | |
|---|---|---|---|---|---|---|
| | CRYSTAL MATERIAL | | VHR (%) | | RESPONSE | |
| | | VISCOSITY- | BEFORE | AFTER | CHARACTERISTIC | |
| | | DECREASING | EXPOSURE TO | EXPOSURE FOR | τr | τd |
| | KIND | AGENT | BACK LIGHT | 500 HOURS | (ms) | (ms) |
| EXAMPLE 13 | E13 | FORMULA (6-3) | 99.4 | 98.8 | 6.8 | 6.8 |
| | | (25 WT %) | | | | |
| COMPARATIVE | C12 | FORMULA (11) | 99.4 | 92.0 | 6.8 | 6.6 |
| EXAMPLE 12 | | (10 WT %) | | | | |
| COMPARATIVE | E0 | NONE | 99.5 | 99.0 | 10.1 | 11.4 |
| EXAMPLE 13 | | | | | | |

Example 13 was a case where the compound represented by the chemical formula (6-3) was used as the viscosity-decreasing agent, and Comparative Example 12 was a case where the alkenyl compound represented by the chemical formula (11) was used as the viscosity-decreasing agent. As shown in Table 6, the VHR of the liquid crystal cell of Example 13 was hardly lowered after the exposure for 500 hours compared to that before the exposure. The VHR of the liquid crystal cell of Comparative Example 12 was remarkably lowered after the exposure for 500 hours compared to that before the exposure, although the content of the viscosity-decreasing agent was as small as 10% by mass. In Comparative Example 13 in which the negative liquid crystal material E0 containing no viscosity-decreasing agent was used, the lowering of the VHR was small after the exposure for 500 hours. The response characteristic in Example 13 was at the same level as that in Comparative Example 12, and Example 13 and Comparative Example 12 exhibited higher speed responses than that in Comparative Example 13 containing no viscosity-decreasing agent.

1. A negative liquid crystal material comprising:
a liquid crystal compound having a negative dielectric anisotropy; and
a viscosity-decreasing agent represented by the following chemical formula (1): 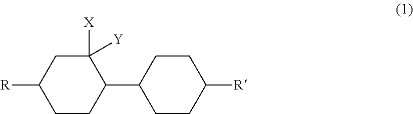
in the chemical formula (1), X and Y are each H or a halogen group, and at least one of X and Y is a halogen group; and R and R′ are each a linear saturated alkyl group having 1 to 5 carbon atoms or a linear saturated alkoxy group having 1 to 5 carbon atoms.

2. The negative liquid crystal material according to claim 1, wherein the liquid crystal compound has either a functional group represented by the following chemical formula (2-1) or a functional group represented by the following chemical formula (2-2): 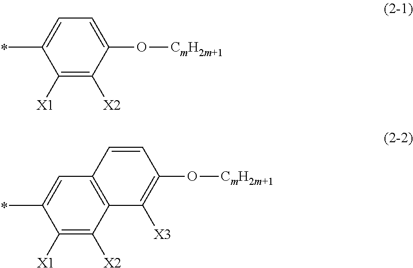
in the chemical formula (2-1) and the chemical formula (2-2), X1, X2, and X3 are independent from each other, and each include an F group or a C1 group; m is an integer of 1 to 18; and “*” represents a bond.

3. The negative liquid crystal material according to claim 1, wherein the liquid crystal compound has a functional group represented by the following chemical formula (2-3): 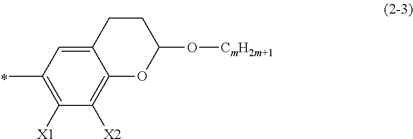
in the chemical formula (2-3), X1 and X2 are independent from each other, and each include an F group or a C1 group; m is an integer of 1 to 18; and “*” represents a bond.

4. The negative liquid crystal material according to claim 1, further comprising a monomer represented by the following chemical formula (3):
P1-Sp1-Z1A1-Z2ₙSp2-P2 (3)
in the chemical formula (3), P1 and P2 are each independently a polymerizable group including an acrylate group or a methacrylate group; Sp1 and Sp2 are each independently a spacer group, which is a linear, cyclic, or branched saturated alkyl group or unsaturated alkyl group having 1 to 24 carbon atoms, or a direct bond; Z1 and Z2 are independent from each other, and each a group: —O—, a group: —S—, a group: —CO—, a group: —COO—, a group: —OCO—, or a direct bond; Al is a 1,4-phenylene group, a 4,4′-biphenylene group, a 2,6-naphthalene group, a 2,6-anthracene group, a 2,7-phenanthrene group, a 4,4′-chalcone group, or a 4,4′-azobenzene group; and n is an integer of 1 to 3.

5. The negative liquid crystal material according to claim 1, further comprising a vertical alignment additive.

6. The negative liquid crystal material according to claim 1, wherein the viscosity-decreasing agent is included in a content of 5% by mass or more and 40% by mass or less.

7. The negative liquid crystal material according to claim 1, wherein the viscosity-decreasing agent is represented by the chemical formula (1) where X and Y are both the F groups, and R and R′ are both the linear saturated alkyl groups having 1 to 5 carbon atoms.

8. A liquid crystal cell comprising:
a pair of substrates facing each other; and
a liquid crystal layer disposed between the substrates and including the negative liquid crystal material according to claim 1.

9. The liquid crystal cell according to claim 8, wherein
the negative liquid crystal material includes the negative liquid crystal material according to claim 4 including a monomer represented by the chemical formula (3), and
the liquid crystal cell comprises a polymer layer including a polymer of the monomer and formed on each facing surface of the pair of substrates.

10. The liquid crystal cell according to claim 8, further comprising a photo-alignment film that is formed on a facing surface of at least one substrate of the pair of substrates and expresses an alignment-regulating property to a liquid crystal compound contained in the negative liquid crystal material by light irradiation.

11. The liquid crystal cell according to claim 10, wherein the photo-alignment film includes at least one photoreactive functional group selected from the group consisting of a cinnamato group, an azobenzene group, and a chalcone group.

12. A liquid crystal display comprising the liquid crystal cell according to claim 8.
